(19) United States
(12) Patent Application Publication
(10) Pub. No.: US 2007/0280305 A1
(43) Pub. Date: Dec. 6, 2007

(54) Q-switched cavity dumped laser array

(76) Inventor: Oved Zucker, Arlington, VA (US)

Correspondence Address: BINGHAM MCCUTCHEN LLP, 2020 K Street, N.W., Intellectual Property Department, WASHINGTON, DC, 20006, US

(21) Appl. No.: 11/446,270

(22) Filed: Jun. 5, 2006

(51) Int. Cl. H01S 3/115; H01S 3/11

(52) U.S. Cl. 372/12; 372/10

(57) ABSTRACT

A microchip, Q-switched, cavity-dumped laser is end-pumped by VCSEL or a laser diode and comprises an electro-optic Q-switch mechanism actively controlled by photoconductive switches. The fast response time of the system and its small dimension produce short pulses (ten pico-second range), with high energy (uJ range). The microchip structure may be built using planar, wafer-like components such that a high-density array of lasers may be manufactured without tight alignment tolerances, providing efficient power or energy scaling.

### FIELD OF THE INVENTION

The present invention relates to optical systems and, more particularly, relates to Q-switched lasers arrays that are capable of cavity dumping and that lend themselves to being built in a compact array format.

### BACKGROUND OF THE INVENTION

Microchip lasers are of great interest due to their compact size, ease of fabrication, high beam quality and use in communications, monitoring and other applications. Examples of microchip lasers and various architectures for operating in the longitudinal mode are given in the following U.S. Pat. No. 5,256,164 to Mooradian; U.S. Pat. No. 5,402,437 to Mooradian; U.S. Pat. No. 5,982,202 to Thony et al.; and U.S. Pat. No. 6,512,630 to Zayhowski. These references do not provide information on how to build an efficient Q-switched laser to produce short pulses, in the 100 pico-second range or less.

Devices have been proposed to obtain pulsed microchip lasers using both passive and active Q-switching techniques. Passive Q-switching of microchip lasers has been obtained, for example, by inserting into the laser cavity a saturable absorber in the form of thin film. This is discussed, for example, in R. Fluck, B. Braun, E. Gini, H. Melchior, and U. Keller, “Passively Q-switched 1.34 um Nd:YVO4 microchip laser with semiconductor saturable-absorber mirrors”, Optics Letters, Vol 22, pp 991-993, 1997; B. Braun, F. X. Kartner, G. Zhang, M. Moser, and U. Keller, “56-ps passively Q-switched diode-pumped microchip laser”, Optics Letters, Vol 22, pp 381-383, 1997; U.S. Pat. No. 6,173,001B1 to Zayhowski; U.S. Pat. No. 6,373,864 to Georges et al.; and U.S. Pat. No 6,400,495 to Zayhowski. However, this technique does not allow tight control of laser operation, such as repetition rate. Moreover, to obtain pulses less than 100 ps, an extremely short cavity must be employed, which limits the size of the gain medium and hence the energy and power delivered by the laser.

Active Q-switching has also been proposed for microchip lasers. It consists of the insertion in the cavity of an electro-optic material to form a Fabry-Perot etalon. This is discussed in J. J. Zayhowski and C. Dill III, “Diode-pumped microchip lasers electro-optically Q switched at high pulse repetition rates”, Optics Letters, Vol 17, pp 1201-1203, 1992; J. J. Zayhowski and C. Dill III, “Coupled-cavity electro-optically Q-switched Nd:YVO4 microchip lasers”, Optics Letters, Vol 20, pp 716-718, 1995; U.S. Pat. No. 5,381,431 to Zayhowski; U.S. Pat. No. 5,394,413 to Zayhowski and U.S. Pat. No. 5,905,747 to Thony et al. This technique, however, generally does not produce pulses shorter than 200 ps and is not well suited for use in the construction of arrays of lasers

Another technique for active Q-Switched lasers involves the use of electro-optic Pockels cells. This is discussed in U.S. Pat. No. 5,384,798 to Zucker et al. and U.S. Pat. No. 5,394,415 to Zucker et al. This concept is difficult to implement in a microchip laser array due to the large size of the Pockels cell, which increases the cavity size. Moreover, to take full advantage of the microchip architecture, the response time of the device should be extremely fast, typically shorter than the cavity round-trip time of 10 ps, which is not compatible with electronic drivers.

Accordingly, there remains a need for a new laser architecture for active Q-switching and cavity dumping of microchip lasers that is suitable for high density array construction. There is a further need for a laser architecture for active Q-switching and cavity dumping that is capable of generating short, high intensity pulses of less than 100 ps. There is a further need for such a laser architecture to operate in some embodiments as an array capable of producing both coherent and synchronized pulses across all or part of the array.

### SUMMARY OF THE INVENTION

A microchip, Q-switched, cavity-dumped laser array is disclosed. Each laser in the array is end-pumped by VCSEL and comprises an electro-optic Q-switch mechanism actively controlled by photoconductive switches. The fast response time of the system and its small dimension produce short pulses (ten pico-second range), with high energy (uJ range). The microchip structure may be built using planar, wafer-like components such that a high-density array of lasers may be manufactured without tight alignment tolerances, providing efficient power or energy scaling.

According to an embodiment of the invention, a laser comprises a laser cavity including a pockels cell and a birefringent gain medium and a laser pumping source coupled with the laser cavity. In operation, the birefringent gain medium diverts the beam in response to the pockels cell being triggered to dump the laser cavity. The laser may further include a photoconducting switch situated at one end of the laser that triggers the pockels cell when the lasing beam in the lasing cavity reaches a threshold level. The laser may further be implemented as an array of lasers, each having a photoconducting switch that contributes to the triggering of all of the pockels cells in the array.

The Pockels cell itself may comprise a waveguide and an electro-optic material or may constitute a magneto-optic material. The birefringement gain medium may be any such medium, including illustratively Nd:YVO₄ or Nd:YAG. Additionally, the array embodiments may further include a waveguide structure to seed all lasers in the array.

### BRIEF DESCRIPTION OF THE FIGURES

The present invention will be more fully appreciated with reference to the detailed description and appended figures, in which:

FIG. 1A depicts a side view of a single laser according to an embodiment of the present invention.

FIG. 1B depicts a top view of a laser array according to an embodiment of the present invention.

FIG. 2 depicts the material Nd:YVO4 as a beam displacer according to an embodiment of the present invention.

FIG. 3A depicts a cross section and top view of the top layers of a laser according to an embodiment of the present invention.

FIGS. 3B and 3C depict a circuit model of the pockels cell, electrode structure and photoconductive switch according to an embodiment of the present invention.

FIGS. 4A and 4B depicts a seeding from CW lasers for coherence according to an embodiment of the present invention.

### DETAILED DESCRIPTION

A microchip, Q-switched, cavity-dumped laser array is disclosed. Each laser in the array is end-pumped by VCSEL and comprises an electro-optic Q-switch mechanism actively controlled by photoconductive switches. The fast response time of the system and its small dimension produce short pulses (ten pico-second range), with high energy (uJ range). The microchip structure may be built using only planar, wafer-like components such that a high-density array of lasers may be manufactured without tight alignment tolerances, providing efficient power or energy scaling.

### Laser Structure

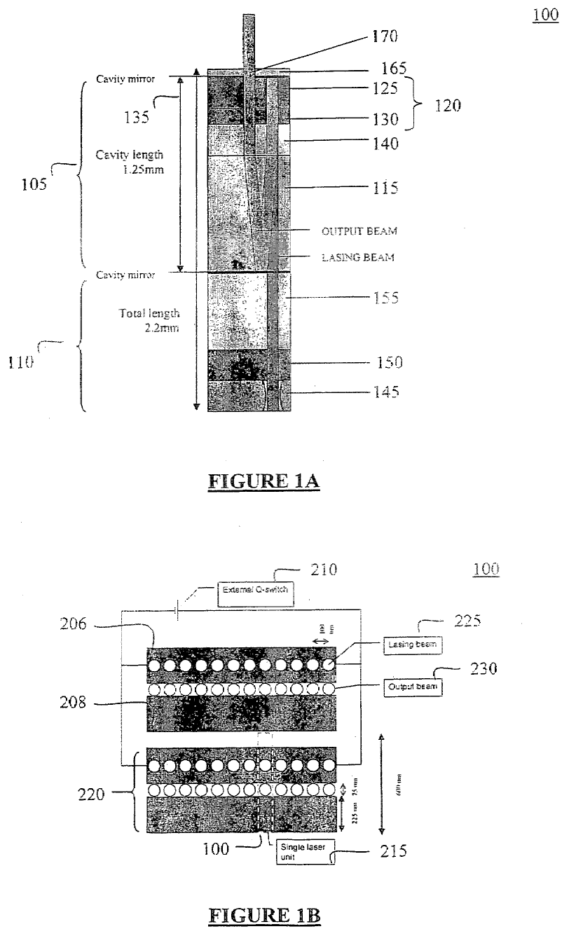

An illustrative laser structure according to an embodiment of the present invention is shown in FIG. 1A. Referring to FIG. 1A, the laser 100 includes a laser cavity section 105 and an optical pumping section 110. The laser cavity section 105 includes a lasing material layer 115, which may comprise any convenient lasing material, such as Nd:YVO₄, a Pockels cell 120 and cavity mirrors 135 defining the length of the laser cavity and the beam path. The laser cavity section may further include a microlens 140 to ensure a stable cavity design and collimation of the laser beam.

According to one embodiment of the invention, the laser cavity may be implemented in a microchip in stacked layers as shown in FIG. 1A. The pockels cell 120 may further comprise an electro-optic material 125 and a waveplate 130. In addition, a silicon layer may be included at the output end of the laser cavity that includes an embedded photoconductive switch that facilitates active Q-switching operation and cavity dumping. The high reflectivity mirrors 135 defining the cavity limits are directly coated on one side of the gain medium and at the top of the Pockels cell. It will be understood that FIG. 1A is merely illustrative, and that variations in the order and size of the microchip layers shown may be implemented to achieve particular design objectives.

The optical pumping section 110 includes a laser that CW pumps the laser cavity section 105 with a beam. According to one embodiment, the laser 145 may be implemented as a high power VCSEL that is integrated with the microchip structure as shown. The optical pumping section may further include a microlens 150 between the VCSEL and the laser cavity 105 that collimates the beam from the VCSEL and passes it through to the laser cavity 105. A microchannel cooler 155 may be implemented within the pumping section 110 to pass the beam and keep the laser 100 from overheating during operation.

To achieve pico-second pulses, a short cavity is needed, which limits the number and size of the various components. According to one exemplary embodiment of the invention, the cavity size may be approximately 1.25 mm, which corresponds to a cavity round-trip time of 18 pico-seconds, and the total size of the structure including optical pumping is 2.2 mm. Such a short cavity and total size for actively Q-switched microchip laser may be obtained through the use of dual function components: for instance, the use of Nd:YVO₄ crystal may be used as the gain medium of the laser to realize both the gain medium and a polarizing beamsplitter due to its birefringent properties; the silicon layer may provides the function of a photoconductive switch, as described further below, and output window for laser; the microchannel cooler, located outside the laser cavity 105, may cool both the gain medium and the pumping VCSELs. However, different and even less efficient arrangements may be implemented when longer cavity lengths and pulse times are tolerable.

When implementing the laser 100 in an array, the array structure may be defined by the VCSEL or laser array 145 used to pump and the electrode patterns on the Pockels cell 120. All the other components are wafers, which don't require precise alignment procedures.

### Laser Operation

The main components of an embodiment of the invention are the polarizing beamsplitter incorporated into the gain medium 115 in some embodiments, the Pockels cell 120 and the photoconductive switch.

The polarizing beam splitter is used to tune the loss of the cavity. Its function is to change the beam path in the cavity depending on the polarization of the light in the cavity 105. In most lasers, the polarizing beam splitter is component is a prism, or a cube beamsplitter. The main disadvantages are that it is a bulk component, usually not planar and thus difficult to integrate into a microchip and a microchip laser array. To overcome these problems, a birefringent crystal may be used as the gain medium. For example, Nd:YVO₄, which is a birefringent crystal, may be used as the gain medium of the laser cavity 105. In addition to the lasing properties, the birefringent properties of the crystal may be used to form a beam displacer that act as a beamsplitter. This is shown in FIG. 1A where the beam reflecting off of the top cavity mirror 135 is shown to diverge from the incident beam beginning at its arrival at the gain medium 115. This is also shown in more detail in FIG. 2, where the reflected beam 255 is shown to diverge from the original beam 250 by θ degrees and produce an output beam 260.

In the cases shown, illustrated as a vertical laser, depending on the initial polarization of the light, the output beam is laterally displaced compared to the input beam. This allows significant simplification in the overall design by allowing a planar component to be used while keeping the cavity size small. Moreover, by combining gain medium and beamsplitter in the same element, element 115, a larger gain medium piece may be used for the same cavity length, which allows the microchip laser to reach higher energy than conventional microchip lasers where the cavity size is limited.

The thickness needed for the medium 115 may be determined based on the displacement required to shift the laser beam by its own size or another desired amount. For example, assuming the cavity produces a Gaussian beam, and using a cavity length of 1.25 mm, the beam size is approximately 75 um. Based on the birefringence properties of YVO₄, the thickness may be approximately 750 um to shift the beam by its own size.

The electro-optic Pockels cell 120 is used for Q-switching by controlling the polarization of the laser beam. The properties of the Pockels cell may be summarized as follows. It generally may need to hold high voltage in some embodiments, to provide a uniform electric field through the crystal and maintain a small size. The configuration for the electro-optic material 125 of the pockels cell 120 may be longitudinal, as shown in FIG. 1A. In this configuration, the polarization rotation is independent of the material length, thus allowing small size. Moreover, materials with small thickness can hold higher electric field than bulk thus offering an additional advantage. Any types of electro-optic material may be employed in this configuration, including the well-known KDP material. However, as a preferred embodiment, the electro-optic material 125 may be CdTe. Its advantages over KDP are that it has a smaller driving voltage, larger damage threshold (1 GW/cm² for ps pulses) and smaller dielectric constant. The latter makes the Pockels cell more efficient in terms of energy. Due to the small thickness of the Pockels cell (200 um) according to some embodiments, the residual absorption of CdTe for wavelength around 1 um is not an issue.

The addition of a waveplate 130 in the Pockels cell 120 is optional. When implemented, it may help reducing the driving voltage for the Pockels cell by introducing a fixed amount of polarization loss. It also may tend to prevent the laser from lasing by itself in absence of Q-switch controls. Without a waveplate 130, this may be obtained by using partial reflectivity mirrors 135 for the cavity.

In order to dump the laser cavity, the voltage on the Pockels cell 120 is turned off (or reduced considerably) much faster than the cavity transit time. Thus, the external switch used for turning on the Q-switch mechanism cannot be used for this purpose. Instead we use a photoconductive switch 170, embedded in a semiconductor layer in the path of the output beam.

In a preferred embodiment, the photoconductive switch 170 is made within the silicon layer 165. The thickness of the silicon layer and the depth of the doping is determined by the absorption of the silicon at the lasing wavelength and the desired triggering level. However, it is understood that other materials than silicon can also be used to provide the same function such as GaAs or other semiconductor materials. The material choice is dictated by the desired operating wavelength.

FIG. 1B illustrates a top view of an array of lasers 100. Referring to FIG. 1B, an illustrative externally triggered Q-switch 210 is shown coupled to an electrode pattern 205 covering an array of lasers 100. Each laser may be spaced 100 micros apart, for example. Voltage may be applied from the external Q-switch to the electrodes and electrode patterns 205 as shown. In the array configuration shown, there are two electrodes above each laser 100. One electrode 206 is coupled to the Q-switch voltage and the other is not. Moreover, the pattern of the electrodes is such that there is a hole in the electrode aligned with the lasing beam from the cavity. There is also a hole in the other electrode aligned with the output beam from the cavity of each laser 100. In this manner an array of lasers 100 may be provided that are triggered by a common Q-switch.

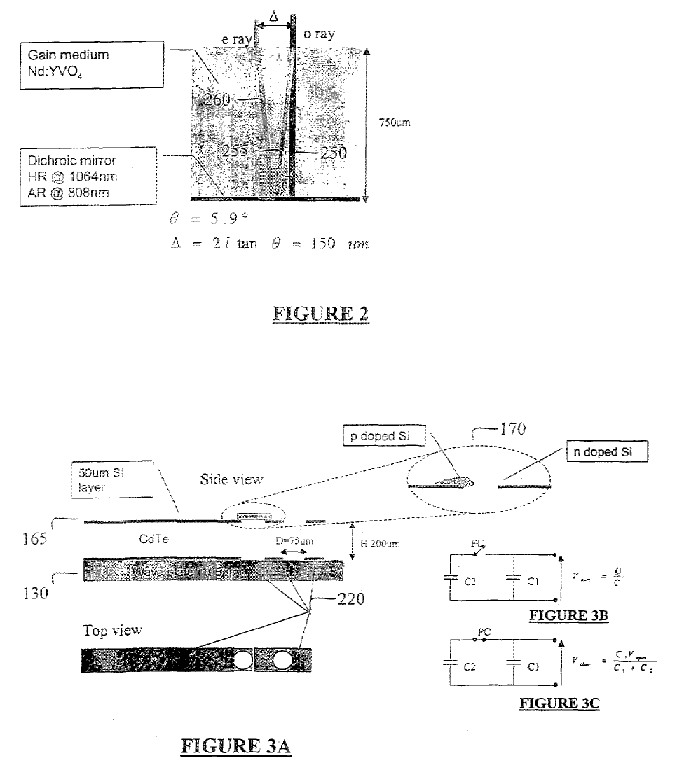

FIG. 3A illustrates a cross section of the upper layers of the cavity portion of the laser 100. Referring to FIG. 3A, the electrode pattern 220 is illustrated, including the waveplate 130 and the mirror 135, both of which form electrodes 220, and the photoconductive switch 170 formed within the silicon 165. The photoconductive switch is triggered by the residual polarization loss of the lasing beam. When triggered, the photoconductive switch discharges the capacitance formed by the Pockels cell 120 into a larger capacitance, which reduces the voltage on the Pockels cell. This is shown graphically in FIGS. 3B and 3C. This operation is very fast due to the feedback provided. Indeed, a lower voltage on the Pockels cells means more light diverted by polarization to the switch, which means more reduction of voltage, and so on. With this method, switching time of less than pico-seconds may be expected due to the small beam size of 75 um.

The new voltage on the Pockels cell is governed by the size of the second capacitance compared to the first one. The ratio can be adjusted by changing the area of the electrodes, the dielectric constant of materials used or any other factors affecting capacitance.

The cavity dumping process is based on the charge transfer from one capacitance to another. This process may be further enhanced by charging the first capacitance with a voltage V and the second capacitance with a voltage −V using the external Q-switch. Thus, when the photoconductive switch is closed, the net charge on the first capacitance becomes zero, providing a better modulation in the Q factor of the cavity. Also, this method uses two capacitances of the same size, which may reduce the cross section of a laser. Denser arrays may be built with this method. In the case described here, the cross-section of a single laser is 100×600 um. With such as design, more than 30,000 lasers can be fitted on a two-inch diameter structure.

The operation of the laser array is described as follows: an external trigger puts voltage on the Pockels cells and Q-switches all lasers in the array at the same time. Buildup of the laser beams start. For each laser, a small part of the lasing beam is directed to the photoconductive switch via polarization loss, which is controlled by the applied voltage and the retardation of the waveplate. When amplification of the beam reaches intensity sufficient to trigger the photoconductive switch, the voltage on the Pockels cell drops very fast. Thus, polarization losses become predominant which dumps the cavity along the displaced output beam path and through the output beam opening.

The above description constitutes a preferred embodiment of the invention. Many variations are within the scope of the invention. The following are illustrative examples. The Pockels cell shown and described may be made using an electro-optic material in a transverse configuration. The advantage of such a Pockels cell, despite the need for a more complicated electrode design, is that it requires a lower operating voltage than that of a longitudinal configuration.

In another embodiment, an equivalent of the electro-optic Pockels cell may be realized with magneto-optic or Faraday effect material such as bismuth substituted rare earth iron garnet. Due to their strong Faraday effect, these materials are well suited to build a compact structure acting on the polarization state of the light in the cavity. It will be further understood that the dual purpose gain medium may be implemented with any convenient birefringent gain medium, such as Nd:YVO₄, Nd:YAG or any other convenient material depending on design considerations. Additionally, the microlens array located inside the cavity 105 may not be implemented and one may instead use the thermal lensing due to the heating of the gain medium to produce a stable cavity. Reference is made to U.S. Pat. No. 5,386,427 to Zayhowski for this purpose. Additionally, the pumping VCSEL array may be implemented as a diode array or any other convenient photon generating source.

Additional components may also be added to the structure. Other components that may be added to the system are unlimited, but include nonlinear crystals for frequency conversion, such as harmonics generation or optical parametric oscillation. Reference is made in this regard to J. J. Zayhowski, “Microchip optical parametric oscillators”, IEEE Photonics Technology Letters, Vol 9, pp 925-927, 1997.

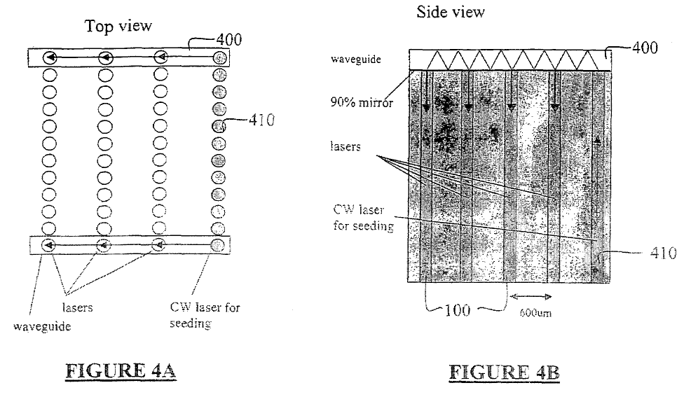

In another embodiment, the laser structure may be modified to ensure coherence of all the lasers in the architecture. This may be accomplished by seeding from CW lasers 410 located on the periphery of an array of lasers 100. The seed is distributed to the lasers through a waveguide structure 400 located on top of the cavity, and enters the lasers through partial reflectivity mirrors. This is shown in the top and side views of FIGS. 4A and 4B.

It should be noted that the photoconductive switch in each laser structure allows dumping the cavity when the lasing beam reaches a given level. However, all the Pockels cells electrodes may be linked together in some array configurations to realize a synchronized design. In this scenario, when a photoconductive switch discharges a cell it also helps to trigger its neighbors. The result is that all the lasers tend to be synchronized. This synchronization, when used with the seeding described, contributes to the coherence of all lasers. While the synchronization may be realized in the manner just described, lasers also may be implemented with electrodes that are interconnected or not interconnected, such that each laser is driven and discharged independently from one another.

While particular embodiments of the present invention have been described herein, it will be understood that changes may be made to those embodiments without departing from the spirit and scope of the present invention.

What is claimed is:

1. A laser, comprising:
a laser cavity including a pockels cell and a birefringent gain medium; and
a laser pumping source coupled with the laser cavity;
wherein the gain medium diverts the beam in response to the pockels cell being triggered.

2. The laser according to claim 1, further comprising:
a photoconducting switch situated at one end of the laser that triggers the pockels cell when the lasing beam in the lasing cavity reaches a threshold level.

3. The laser according to claim 2, further comprising:
an array of lasers, each having a photoconducting switch that contributes to the triggering of all of the pockels cells.

4. The laser according to claim 1, wherein the pockels cell comprises a waveplate and an electro-optic material.

5. The laser according to claim 1, wherein the birefringent gain medium comprises Nd:YVO₄.

6. The laser according to claim 1, wherein the birefringent gain medium comprises Nd:YAG.

7. The laser according to claim 1, wherein the Pockels cell uses a magneto-optic material controlled by a photoconductive switch.

8. The laser according to claim 1, further comprising a waveguide structure to seed all lasers in the array.

9. The laser according to claim 1, further comprising a microlens in the laser cavity.

10. The laser according to claim 1, wherein the laser pumping source is a VCSEL.

11. The laser according to claim 10, wherein the VCSEL is formed integrally with the laser cavity in a microchip structure.

12. The laser according to claim 1, further comprising a microchannel cooler integrated with the laser pumping source.

13. A method of providing an array of lasers, comprising:
forming a plurality of longitudinally oriented lasers, each comprising a laser cavity including a pockels cell and a birefringent gain medium, a laser pumping source coupled with the laser cavity and wherein the gain medium diverts the beam in response to the pockels cell being triggered; and
forming common electrodes for triggering the lasers, one of the electrodes being capable of conveying a trigger from a Q-switch to the plurality of lasers.

14. The method according to claim 13, further comprising:
providing waveguide structure to convey a seed laser beam to the plurality of longitudinally oriented lasers.

15. The method according to claim 14, further comprising providing a seed laser capable of generating a beam conveyed over the waveguide structure for seeding the array.

16. The method according to claim 13, in which the peak power of the laser is maximized by optimizing the gain medium size and reducing the Pockels cell size to create short pulses with high energy.

17. The method according to claim 13, wherein the alignment constraints of the array are above minimum tolerances.

18. The laser according to claim 1, wherein the cavity length is designed to be as short in length as possible.

19. The laser according to claim 1, wherein the birefringent gain medium act as both a gain medium and a polarizer and further comprising a photoconducting switch situated at one end of the laser that triggers the pockels cell when the lasing beam in the lasing cavity reaches a threshold level.

20. The laser according to claim 1, wherein the laser source is a vcsel and the birefringent gain medium and the size of the laser cavity are compatible with the vcsel beam size.

21. The laser according to claim 1, wherein the Pockels cell allows a response time shorter than the round trip time of the cavity, therefore providing a method for efficient cavity dumping.

22. The laser according to claim 1, further comprising a partial reflectivity mirror to amplify for an incoming beam.

23. The laser according to claim 2, further comprising a partial reflectivity mirror to regeneratively amplify an incoming beam, wherein the number of passes in the gain medium is controlled by the threshold of the photoconductive switch.

24. The laser according to claim 23 integrated into an array.

25. A Pockels cell comprising two sets of electrodes and a photoconductive switch, wherein:
the first set of electrodes acts as a Pockels cell by changing the beam polarization;
the photoconductive switch is intermediate the first and second set of electrodes; and
the second set of electrodes is used to control a voltage applied to the first set of electrodes via the photoconductive switch.

26. The Pockels cell according to claim 25, which is less than a millimeter in length.

27. The Pockels cell according to claim 26, comprising a longitudinal electro-optic arrangement to minimize its thickness

28. The Pockels cell according to claim 25 integrated into an array.

29. The Pockels cell according to claim 28, wherein the electrodes are provided on an at least one of an electro-optic and a magneto-optic material.
